(19) United States
(12) Patent Application Publication
(10) Pub. No.: US 2026/0118859 A1
(43) Pub. Date: Apr. 30, 2026

(54) EXOGENOUSLY INFORMED TECHNIQUES FOR ROBUST AND CYBERSECURE MANUFACTURING SYSTEMS

(71) Applicant: Rutgers, The State University of New Jersey, New Brunswick, NJ (US)

(72) Inventors: Rajiv Malhotra, Rahway, NJ (US); Jeremy Cleeman, Roselle, NJ (US)

(21) Appl. No.: 19/371,775

(22) Filed: Oct. 28, 2025

Related U.S. Application Data
(60) Provisional application No. 63/712,658, filed on Oct. 28, 2024.

(51) Int. Cl. G05B 19/418

(52) U.S. Cl. CPC G05B 19/41875; G05B 2219/32368

(57) ABSTRACT

Described herein are systems and methods for adaptive control of production processes. In some embodiments, the systems and methods utilize artificial intelligence, such as reinforcement learning (RL), to adjust process parameters in response to detected defects or disturbances. In some embodiments, the systems and methods may be configured to respond to changes in process conditions, including those arising from environmental variability, operational dynamics, or cyber-physical disruptions. The disclosed techniques may be applicable across a range of manufacturing modalities and may be implemented in various production environments. In some embodiments, the systems and methods may improve process resilience, reduce defect propagation, and enhance product integrity without interrupting production.

### RELATED APPLICATIONS

This application claims priority to U.S. Provisional Application No. 63/712,658, filed Oct. 28, 2024, the entire content of which is incorporated by reference herein.

### FIELD

The present disclosure relates to adaptive process control systems for production processes, and more specifically, to a reinforcement learning-based method for adjusting process parameters in response to quantified product defects and changes in exogenous factors.

### SUMMARY

Manufacturing processes have become increasingly complex, making it challenging for control systems to maintain product quality and efficiency. Some control methods struggle to adapt to the dynamic nature of modern manufacturing environments, particularly when faced with unexpected disturbances or subtle alterations in process parameters. Challenges in the manufacturing processes includes developing control systems that can effectively respond to changes in exogenous parameters. The exogenous parameters represent factors not directly controlled but impacting the production process. Additionally, quantifying and responding to defects during the fabrication process without halting production (e.g., real-time) remains challenging, as systems may rely on post-production quality control.

For example, increased integration of information and operational technologies has enhanced the manufacturing enterprise but has also opened the door to malicious software or firmware that can perturb processes and machines in ways that induce defects (e.g., voids) and thus deteriorate a product's material integrity (e.g., stiffness and strength). Such attacks have significant national security and socio-economic implications since they can harm the function or life of aerospace, automotive, semiconductor, biomedical, and defense parts in a way that may be difficult to detect. Also, while in-situ monitoring can detect defects, existing production processes typically respond to detection of defects by disposing of products and stopping production until vulnerabilities can be addressed (e.g., information technology (IT) solutions patch the vulnerability). These responses, however, come at a high cost, especially for mission-critical products or when product resources are scarce.

Also, attacks and other sources of distributions can affect endogenous process conditions (e.g., real-time controlled parameters like extrusion rate in FFF)) or exogenous conditions that are not real-time controlled (e.g., cause deviation in lateral stepover between adjacent roads to create inter-road voids in FFF). Both endogenous and exogenous parameters may have nonlinear effect on material behavior as well as defect formation dynamics. Also, a combination of attacked process conditions (i.e., the attack path) can intermittently change in an a-priori unknown manner to preclude defense based on pattern recognition. For example, the typically large number of process conditions makes it difficult to a-priori identify all possible attack paths, and the similar effect of different attack paths on a defect makes real-time root-cause-analysis intractable. Thus, secure control for cyberphysical systems and real-time control based on bias correction can require known and/or repeatable attack paths and real-time feedback control (e.g., proportional-integral-derivative PID control) cannot handle attacks on exogenous conditions since they assume linear defect-parameter relationships. In addition, changing endogenous parameters incrementally by a constant amount yield low spatial resolution of recovery (e.g., inability to perform sub-road recovery in FFF). Accordingly, model predictive control either requires a repeatable attack path or the typically infeasible incorporation of all the exogenous parameters into a defect model, and real-time control based on reinforcement learning (RL) or other machine learning methods is specific to the fixed exogenous conditions for which the machine learning correlation is derived.

Accordingly, examples provided herein can recover from such attacks and other sources of defects by disrupting defect formation without discontinuing part production. The disruption minimizes the spatial extent of defects to mitigate reduction in product functionality. For example, in response to detecting inter-road voids in FFF, examples described herein recover void-free printing in less than a single road to limit deterioration of the product's strength and stiffness. In particular, examples described here provide an artificial intelligence-based (AI-based) framework to bridge the above noted gaps and provide recovery from detects induced by intermittent, random, and previously unknown attacks on both exogenous and endogenous process conditions. For example, in the context of FFF, examples described herein can provide sub-road recovery from inter-road voids induced by intermittent, random, and previously unknown attacks on both exogenous and endogenous process conditions. As described in more detail herein, examples described herein combine real-time defect quantification (e.g., via machine vision or other sensing technologies) with (i) an experimental-data-drive defect dynamics model and (ii) a RL-controller.

In other words, examples provided herein address the noted challenges through a RL-based approach in adaptive production control. This approach includes using quantified defects as a direct measure of the current state and training the RL model to respond to changes in exogenous parameters. This approach provides a technical solution to one or more technical problems by, for example, adaptively adjusting the production process in response to changes in exogenous parameters particularly when faced with unexpected disturbances or alterations in process parameters, therefore improving the functioning of production control systems in various manufacturing environments.

Other examples include an AI-based method that mitigates defects during the fabrication process without halting production (e.g., real-time) and automated mitigation of defects created in manufacturing processes including, for example, operation of the manufacturing process in dynamic environments (e.g., shaking platforms like trucks, planes, ships, etc.), changing environmental conditions (temperature, humidity, etc.), and cyberattacks that affect the process parameters and introduce defects in parts, which is often experienced in emerging cyber-manufacturing systems. Some applications may be in the defense, aerospace, and automotive manufacturing sectors and may be used in cybersecurity, cyber-manufacturing, and extreme manufacturing. For example, some examples described herein may be used in point-of-need manufacturing in 3D printing.

Additionally, the defect dynamics model may predict the future value of an in-situ quantifiable defect metric (e.g., a defect state, such as an areal void fraction in FFF) given its current value and the current and future values of the endogenous process parameters (e.g., an action, such as a filament speed in FFF). This model goes beyond conventional defect classification and regression of the defect metric over static endogenous parameters.

Further, the RL controller may include a neural network policy whose inputs are a current value of a defect metric and a current value of the endogenous real-time controllable parameter. The policy's output is the future value of the endogenous parameter that allows recovery. This approach uses the insight that under attacks on exogenous conditions and with nonlinear process dynamics, the future state of a defect depends not only on its current state and the future action value, but also on the current action value. This also allows the RL controller to recover from attacks on exogenous condition the controller was previously untrained for and, therefore, eliminates the need to explicitly enumerate attack paths.

The methods, systems, and apparatuses provided herein may adjust across multiple types of changes in previously unseen or untrained exogenous changes without requiring retraining and correct/mitigate defects at a speed that is an order of magnitude faster than some existing methods. For example, some conventional or AI-based methods (such as some conventional RL methods, MPC control, PID control, and disturbance rejection control) cannot adjust to previously unseen exogenous changes. These methods cannot correct for defects in a manner that avoids loss in the part's operational performance.

Examples described herein provide methods and systems for adaptive process control in production processes, such as, for example, in additive manufacturing including three-dimensional (3D) printing processes. While aspects may be described herein using a 3D printing process as an example, the methods and systems described herein can be used with various types of production processes and is not limited to any particular process or example.

According to some examples, a computer-implemented method is provided that includes obtaining a current state parameter of a production process and a current action parameter of the production process, the current state parameter represented by a quantified defect of a product being processed by the production process; determining, using a controller including a reinforcement learning (RL) model receiving the current state parameter and the current action parameter as inputs, a future action parameter of the production process; and performing the production process using the controller by applying the future action parameter to the production process.

According to some examples, a system for performing adaptive process control is provided that includes a sensor configured to obtain data representing a defect in a product being processed via a production process; a controller including a reinforcement learning (RL) model, the controller configured to: obtain a current state parameter of the production process determined based on the data obtained by the sensor; obtain a current action parameter of the production process; determine, with the RL model receiving the current state parameter and the current action parameter as inputs, a future action parameter of the production process, and generate a control signal to adjust the production process by applying the future action parameter to the production process; and an output interface configured to transmit the control signal.

According to some examples, a computer-implemented method for training a reinforcement learning (RL) model for adaptive process control includes generating a training dataset including a plurality of training samples of a production process, each training sample including a current state parameter of a production process and a current action parameter of the production process and each training sample obtained while altering a single exogenous parameter of the production process, the current state parameter represented by a quantified defect of a product being processed by the production process; and training the RL model using the training dataset to determine a future action parameter based on the current state parameter and the current action parameter of the production process.

Other examples, features, and aspects will become apparent by consideration of the detailed description and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A schematically illustrates information flow for a real-time defect correction apparatus according to some examples.

FIG. 1B illustrates an example image of an inter-road void with annotations.

FIG. 2A illustrates the evolution of filament speed and void fraction during an attack on endogenous parameters, where filament speed is reduced to 25% of its nominal value.

FIG. 2B illustrates visual recovery from the filament speed attack of FIG. 2A, showing the road-to-road interface during sub-road correction.

FIG. 2C illustrates filament speed and void fraction during an attack on a trained exogenous parameter, where lateral stepover is intermittently increased.

FIG. 2D illustrates visual recovery from the lateral stepover attack of FIG. 2C, showing the road-to-road interface during repeated sub-road corrections.

FIG. 2E illustrates filament speed and void fraction during an attack on an untrained exogenous parameter, where extruder speed is doubled.

FIG. 2F illustrates visual recovery from an extruder speed attack, showing the road-to-road interface during sub-road correction.

FIG. 3 illustrates examples of part integrity alterations caused by malware across different manufacturing processes.

FIG. 4 depicts changes in part functional integrity over various phases, emphasizing recovery behavior.

FIG. 5A depicts endogenous and exogeneous process parameter deviations in filament fabrication resulting from cyber-physical attacks according to some examples.

FIG. 5B illustrates the inconsistent nature of attacked induced defects through the presence of localized defects across multiple units of the same part according to some examples.

FIG. 6 illustrates limitations and losses associated with existing system-level recovery methods according to some examples.

FIG. 7 illustrates limitations of potential process plan recovery methods for mitigating attacks according to some examples.

FIG. 8 schematically illustrates a process workflow for defect detection and recovery for a three-dimensional printing application according to some examples.

FIG. 9 schematically illustrates a process workflow for defect detection and quantification used as part of the process workflow of FIG. 8 including image segmentation results for a captured image according to some examples.

FIG. 10 schematically illustrates process workflow for reinforcement learning used as part of the process workflow of FIG. 8 according to some examples.

FIG. 11 schematically illustrates a real-time defect correction apparatus according to some examples.

FIG. 12 schematically illustrates a reinforcement learning (RL) controller included in the apparatus of FIG. 11 according to some examples.

FIG. 13 schematically illustrates the information flow for a defect dynamics model included in the apparatus of FIG. 11 according to some embodiments.

FIG. 14 illustrates a method for adaptive production control using the real-time defect correction apparatus of FIG. 11 according to some embodiments.

FIG. 15 illustrates a method for training the RL controller of FIGS. 11 and 13 according to some embodiments.

### DETAILED DESCRIPTION

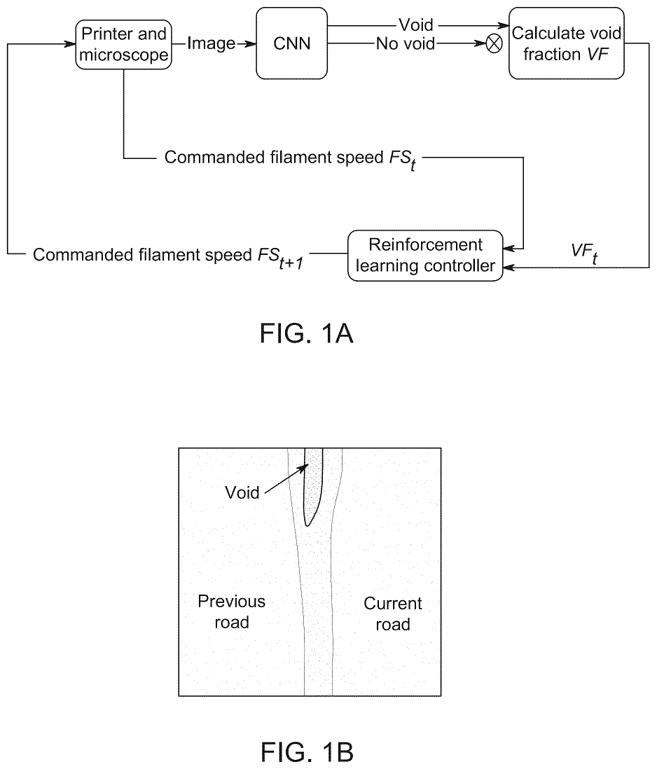

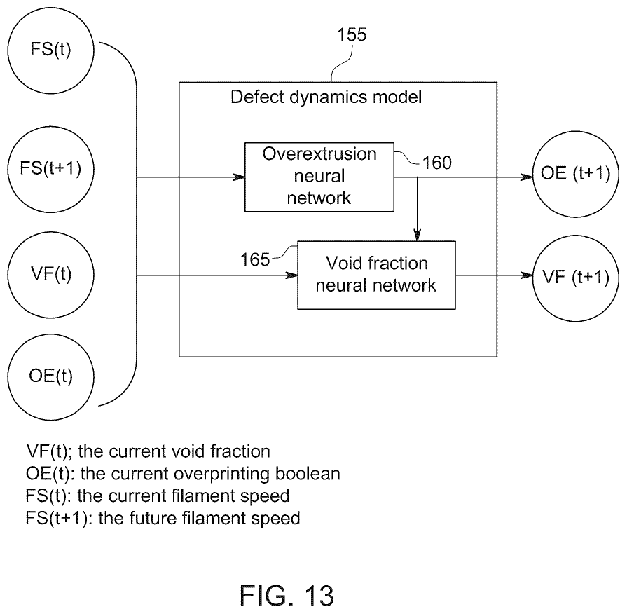

FIG. 1A illustrates information flow during real-time recovery in fused filament fabrication (FFF) according to some examples of the methods, systems, and apparatuses described herein. FIG. 1B illustrates an example image of an inter-road void captured during printing. In this example, a digital microscope (e.g., a Universal Serial Bus (USB) microscope) fixed on the extruder images the interface of adjacent roads. These images are process by a machine vision model implemented as a convolutional Neural Network (CNN), which classifies the current printing state at time t as one of a plurality of states (e.g., Void, No Void, or Overprinting). For images with voids, the areal void fraction VF=Aᵥ/Aᵢ is calculated (e.g., via color image segmentation), where Aᵢ is the total pixel area of the image and Aᵥ is the pixel area constituting the void. The VF at the current timestep (VFₜ) and the current commanded filament speed FSₜ are sent to a trained reinforcement learning (RL) controller. In some examples, the RL policy used by the RL controller is a neural network that generates the future commanded filament speed FSₜ₊₁ used by the printer in timestep t+1 to recover from a void. The RL policy may be trained using a defect dynamics model 155 (FIG. 13) to evaluate a reward.

In some examples, the defect dynamics model 155 is a feedforward neural network that predicts a future state (VFₜ₊₁ and overprinting boolean OEₜ₊₁) using inputs of current states (VFₜ and OEₜ) and current and future actions (FSₜ and FSₜ₊₁). The RL reward function may be r=(1−VFₜ₊₁/VFₘ)(1−OEₜ₊₁), where VFₘ is the maximum permitted VF(=0.5 in this example). In this equation, OE equals 0 for no overprinting and 1 for overprinting and the inclusion of this variable the equation creates a learned policy that prevents voids and overprinting.

In some examples, the machine vision module is implemented as a CNN. The CNN is trained and tested on augmented images acquired by experimentally varying filament speed FS between adjacent roads. The defects dynamics model 155 is trained and tested on two-road experiments performed using unique combinations of FSₜ, FSₜ₊₁, VFₜ and OEₜ with the resulting VFₜ₊₁ and OEₜ₊₁ obtained from the trained machine vision module. These combinations of VFₜ and OEₜ may be created by randomly varying the lateral stepover (exogenous parameter) between roads. Thus, the dynamics model 155 and RL policy may be trained on an attack on only one arbitrarily chosen exogenous parameter. In some examples, the RL policy is trained via NeuroEvolution of Augmenting Topologies (NEAT).

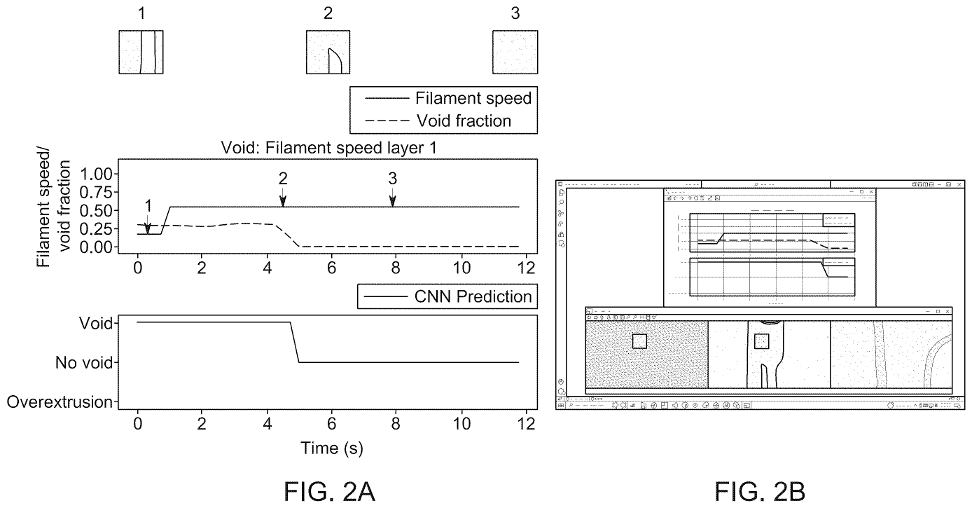

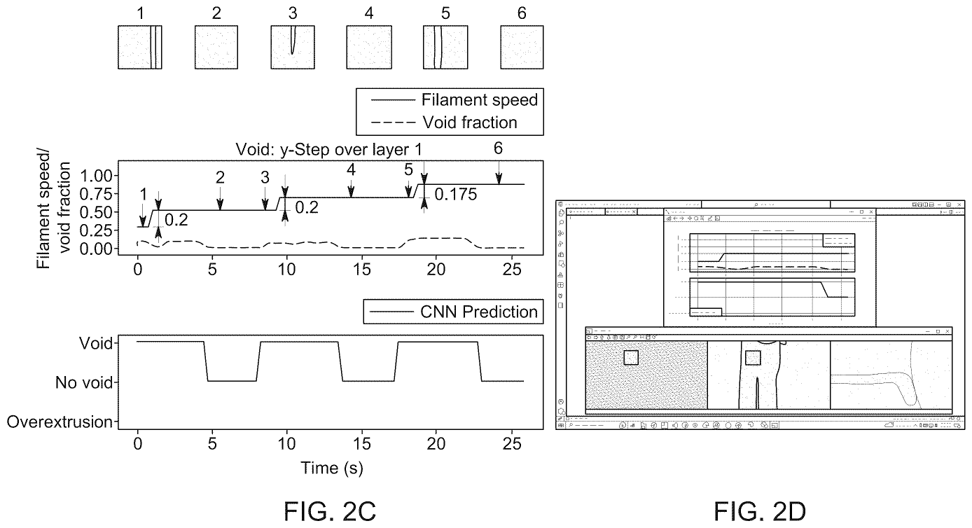

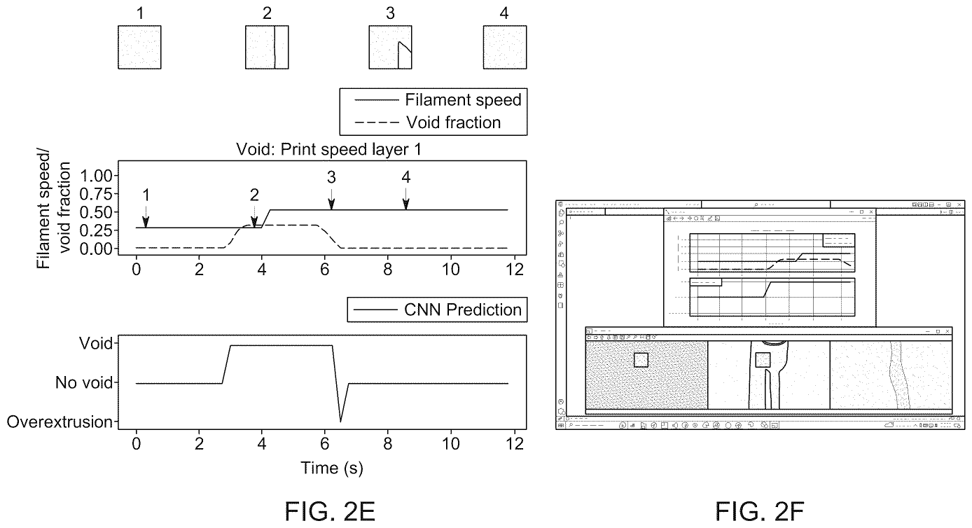

FIGS. 2A-F illustrate results of an example adaptive process control and includes images and videos of road-road interface and evolution of commanded FS, VF, and detected print state for attacks on filament speed (FIGS. 2A and 2B), lateral stepover (FIGS. 2C and 2D), and extruder speed (FIGS. 2E and 2F). In these examples, attacks are emulated by injecting perturbations during printing of the second road. The first test examined attacks on endogenous conditions by reducing FS to 25% of its nominal value. FIGS. 2A and 2B show sub-road recovery in one control action. The second test intermittently increased lateral stepover to examine an attack on a trained exogenous condition. FIGS. 2C and 2D show sub-road recovery from each void in one action. Nonlinear deposition dynamics is captured since the increase in FS for each recovery is different while the perturbation in stepover is the same. The third test doubled the extruder speed to emulate a previously unseen attack on an exogenous parameter. Sub-road recovery was demonstrated in one action (FIGS. 2E and 2F). This single-action sub-road recovery is not possible in FFF using existing solutions. Further, recovery from previously unseen exogenous and endogenous attacks was possible despite the RL policy and defect dynamics model 155 only being trained using one arbitrarily chosen exogenous parameter.

Accordingly, the results illustrated in FIGS. 2A-2F demonstrate that the disclosed AI-based methods, systems, and apparatuses go beyond the state-of-the-art by enabling high-resolution in-process recovery from cyberattacks that induce material integrity defects. These methods, systems, and apparatuses allow recovery from previously unseen attacks on exogenous and endogenous parameters that are intermittent, random, and a-priori unknown. Single-action sub-road recovery is achieved, a hitherto unseen capability in FFF that also has applications in process control beyond cyberattacks. This approach is generalizable across processes where an in-situ measured sensor signal can be quantitatively related to an inline or offline measured degree of defects. Practically, this framework can reside in a Trusted Execution Environment on the control computer's microprocessor to safeguard its integrity.

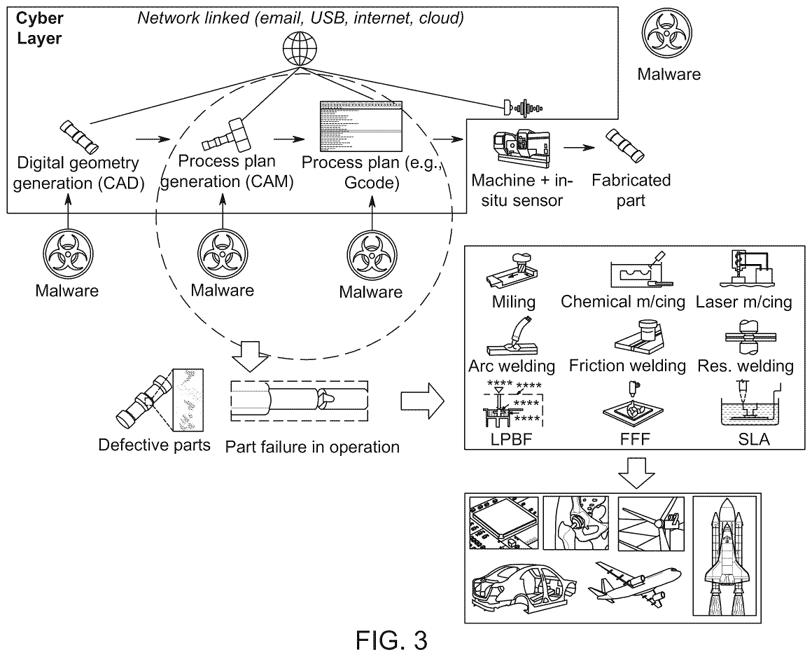

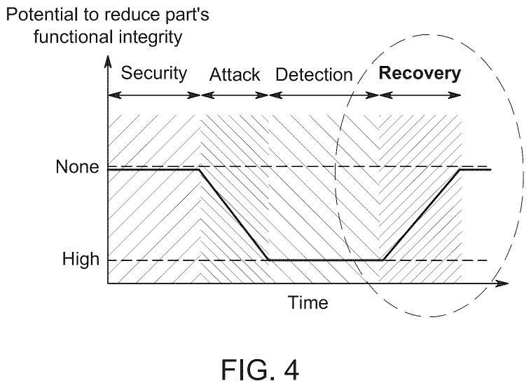

As noted, examples provided herein provide real-time recovery from cyberphysical attacks on manufacturing processes. Regarding part integrity attacks and recovery, connectivity and digitalization in modern manufacturing processes creates pitfalls. Cyberphysical attacks may also reduce a part's functional integrity. Accordingly, examples provided herein may be directed to process plan attacks (see, e.g., FIG. 3) and the recovery stage (see, e.g., FIG. 4) and, as described herein, when security fails and an attack is detected in a connected system that employs defense-in-depth, stoppage-free recovery steps up to eliminate or discontinue attack-induced defect creation without stopping fabrication.

Some challenges of real-time recovery from cyberphysical attacks include: (1) atypical alteration of exogenous parameter set points during or before fabrication, (2) alterations that are a-priori unknown, difficult to identify, and difficult to in-situ measure, and (3) stealthy attacks that are hard-to-catch alterations, e.g., avoiding crashing machines or parameter limits, and sporadic and varying defects to evade post-process quality control.

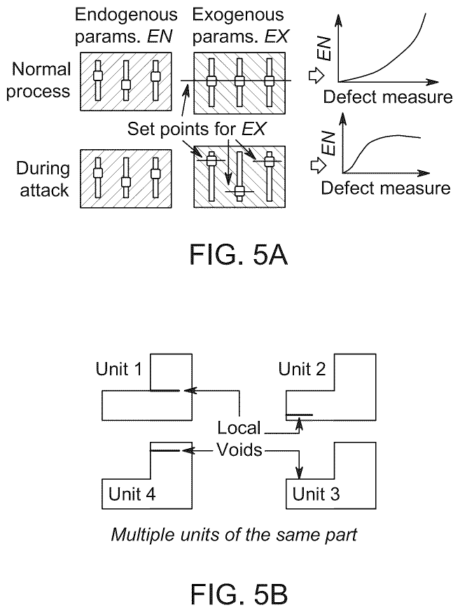

For example, with respect to (1), change in exogeneous parameter set points can change the dynamics of the endo-defect relationship (e.g., for FFF, changes in parameters during fabrication may include datum and, during path planning, nozzle diameter). With respect to (2), what will be changed and by how much is a-priori unknown and it may be difficult to separate (e.g., in real-time) the changes (e.g., both layer height and filament speed alteration can result in similar looking voids). Also, real-time sensing needs a comparison to baselines that might be varying with time in a complex code and real-time sensing maybe difficult (e.g., over-instrumented). In addition, with respect to (3), systems should aim to avoid easy to catch alterations, such as, for example, removing crashing machines or triggering supervisory alarms by breaching process parameter limits. Also, defects may be difficult to catch via a post-process measurement that is typically not performed for every unit (e.g., a manufacturer cannot break every unit to test strength). As used herein, endogenous parameters are parameters that are varied during fabrication, e.g., filament speed and stage speed (see, e.g., FIGS. 5A and 5B), and exogenous parameters are fixed at a set-point before fabrication starts, e.g., datum, nozzle diameter, nozzle height, hot-end temperature, lateral stepover, etc.

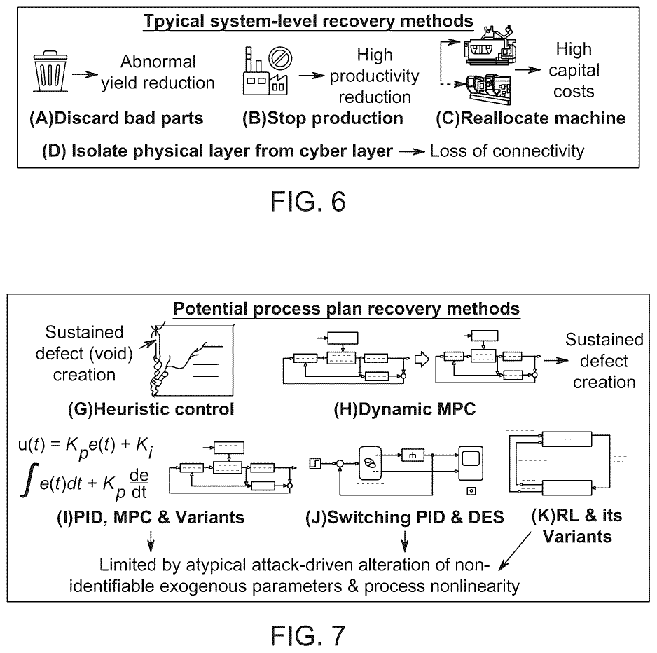

As illustrated in FIGS. 6 and 7, state-of-the-art recovery incurs significant loss in productivity, yield, connectivity, part integrity, and/or cost-effectiveness, and hinders adoption of connected manufacturing and associated technology and industries. Specifically, FIG. 6 shows examples of typical system-level responses to cyberphysical attacks including discarding defective parts, halting production, reallocating production to a different machine, and isolating the physical layer. These methods result in sustained defect creation and operational disruption, proving to be ineffective methods in defect recovery. FIG. 7 show examples of process plan recovery methods, including heuristic control, dynamic model predictive control (MPC), and switching PID strategies. These methods are constrained by their inability to adapt atypical, non-identifiable alternations in exogenous parameters and nonlinear process dynamics. Accordingly, there is a need for more robust, flexible, and real-time recovery solutions. To address these and other technical issues, examples described herein provide methods, systems, and apparatuses providing defect recovery that is (i) stoppage-free to prevent productivity loss, (ii) applied rapidly and in real-time for every part, and (iii) is scalable by eliminating identification or prior knowledge of attack-altered exogenous parameters.

As one nonlimiting example, the methods, systems, and apparatuses described herein are applied to fused filament fabrication (FFF) using controlled endogenous parameters of filament speed F and stage speed S (with associated) constraints on avoiding physical limits of endogenous parameters) and are configured to detect and recover from defects of overprinting and voids, and attack-altered exogenous parameters of nozzle height, lateral stepover, material, hot-end temperature, and their combinations.

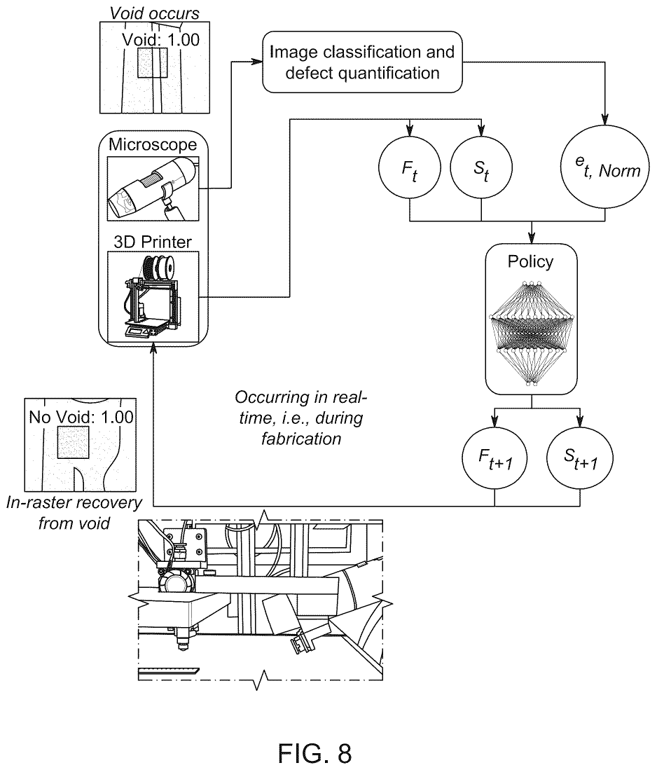

For example, FIG. 8 illustrates a process workflow for defect detection and recovery in FFF. The workflow begins with the occurrence of a defect (e.g., a void) during printing. This defect is detected in real-time using image classification and defect quantification based on microscope-captured images of the inter-road interface. A convolutional neural network (CNN) classifies the image as either “Void” or “No Void,” and a void fraction (VF) is calculated using image segmentation techniques. The current filament speed Fₜ, stage speed Sₜ and normalized error metric et are analyzed and fed into a reinforcement learning (RL) policy model that determines corrective actions. The policy model may be trained using a defect dynamics model 155 and NeuroEvolution techniques (e.g., NEAT) to output future control parameters (Fₜ+1 and Sₜ+1) that guide real-time corrective actions. These actions may be applied immediately to the printing process to recover from the defect within the same raster line (e.g., in-raster recovery). FIG. 8 further includes visual examples of the system's operation. For example, the microscope image labeled “Void: 1.00” indicates a detected defect, and the image labeled “No Void: 1.00” shows successful in-raster recovery (“No Void: 1.00”).

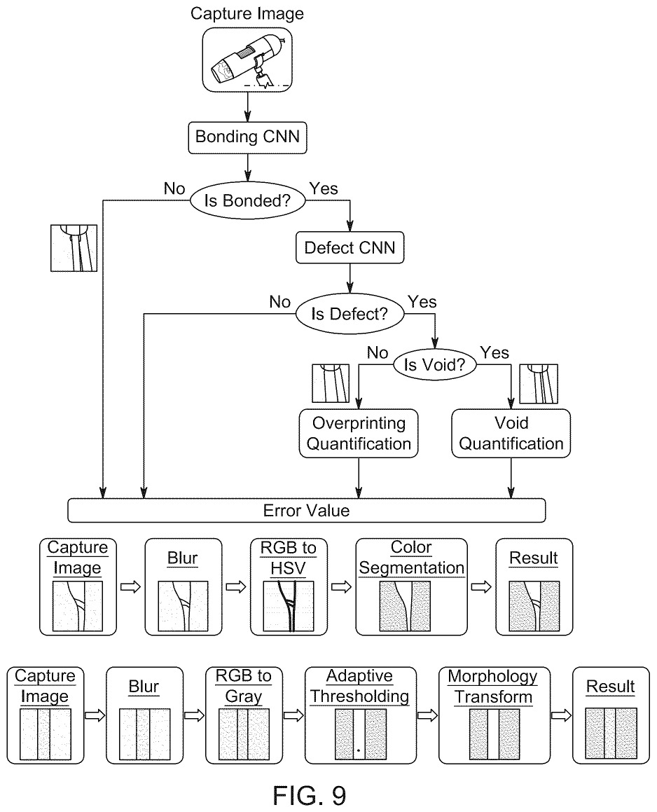

As illustrated in FIG. 9 and as also noted above, in some examples, for defect detection and quantification, one or more convolutional neural networks (CNN) are trained for classifying an image (e.g., with respect to the presence of a void and/or overprinting in real-time). Conventional image analysis can used to quantify void and overprinting defects in terms of pixel fraction. In some examples, the defect detection and quantification process begins with real-time image acquisition during fabrication. A microscope, camera, or other imaging device captures images of the printed surface, and the images are analyzed as part of a multi-stage convolutional neural network (CNN) pipeline. The pipeline may include using a bonding CNN to determine whether bonding is present in the captured image. In response to confirming the occurrence of bonding (via the bonding CNN), a defect CNN evaluates the image to detect the presence of any defects. In response to identifying a defect (via the defect CNN), the defect CNN further classifies the image as representing either a void (e.g., a gap or unbonded region between adjacent printed roads) or an overprinting condition (e.g., excess material deposited beyond the intended boundary).

In some embodiments, the defect CNN may be implemented as two layer-specific models. For example, the defect CNN may use the current printing layer number to determine whether to route the image to CNN-1 if the image is from the first printed layer, or CNN-2 if the image is from a subsequent layer. In some examples, CNN-1 may consist of two convolutional layers, two Max pooling, and two dropout layers followed by a flattening layer. CNN-2 may consist of five convolutional layers, five average pooling layers, three dropout layers, one flattening layer and two dense layers. Each CNN is trained on data specific to its layer type. CNN-1 is optimized for detecting blue pixels (representing exposed build plate) using standard color segmentation. CNN-2 is optimized for detecting dark void and overprinting in filament-colored layers. The appropriate CNN may then classify the defect type as void or overprinting.

For void classifications, the areal void fraction (VF) is computed using image segmentation techniques. If the image is routed to CNN-1, the blue pixels in the image are isolated using standard color segmentation. If the image is routed to CNN-2, the image is converted to greyscale, blurred, and processed using mean adaptive thresholding followed by morphological transformations (e.g., dilation or erosion) to isolate void regions. For overprinting classifications, detection may be binary (OE=1 or 0) and serve as a qualitative indicator. The image is converted to hue-saturation-value (HSV) color space and segmented based on color intensity and saturation to isolate regions of over extrusion.

The defect metrics (VF and OE) may then be used to compute an error signal, which represents the deviation of the current print state from a defect-free condition. This error signal is provided as input to the reinforcement learning (RL) controller, which may be trained to associate specific defect states and process conditions with corrective actions. The RL controller uses the error signal to determine optimal adjustments to one or more real-time controllable process parameters (e.g., filament speed or stage speed) to mitigate defects and maintain print quality.

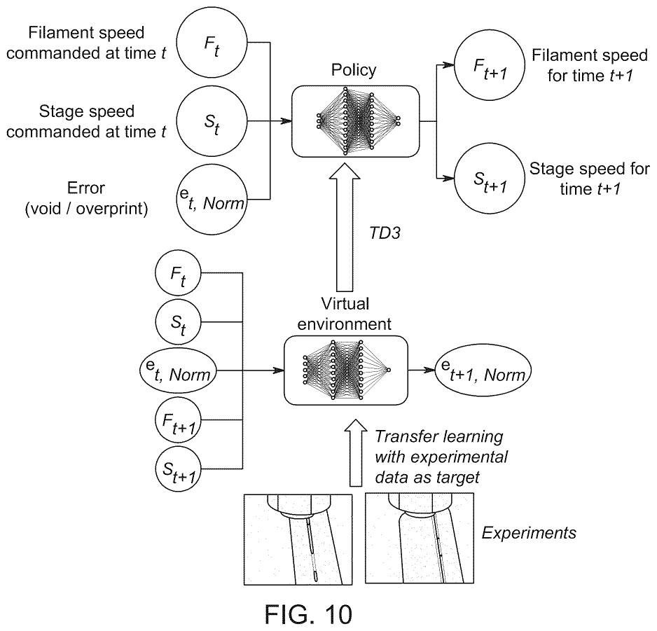

As illustrated in FIG. 10 and as also noted above, in some examples, reinforcement Learning (RL) is used. The RL policy incorporates exogenous parameter alterations without identifying them. The RL policy training is based on alteration of only one exogenous parameter (e.g., lateral stepover), and the policy reward aims to (1) make void/overprinting faction zero by altering F and S during fabrication, and (2) avoid endogenous parameter limits. The RL policy may receive as input the current filament speed (Fₜ), stage speed (Sₜ), and a normalized error metric (e_{t, Norm}), and may output future control parameters (Fₜ₊₁ and Sₜ₊₁) for the next timestep. The training may involve policy training within a virtual environment, and transfer learning of virtual environment.

According to some examples, the training allows the methods, systems, and apparatuses described herein to adapt to unseen changes in exogeneous parameters without requiring policy retraining (e.g., of the first layer and/or the second layer when the training involves two layers). For example, the training may involve two layers (referred to herein as “first” and “second” layers). The first layer may involve altered filament speed, stage speed (endogenous parameter), lateral stepover (exogenous parameter), and PLA material. The second layer may introduce additional, previously unseen variations to evaluate generalization, including changes in material as well as decreased and increased nozzle height. The recovery may be stoppage-free, rapid (for example, approximately 6 seconds or less and in-road correction), and scalable. In some examples, no policy retraining is needed beyond the first layer.

Accordingly, examples described herein include an adaptive method for recovery from cyberattacks that provides (1) recovery and resilience by going beyond security and detection, (2) stoppage-free recovery because the method can be computer-based and the recovery can continue in the background while production continues without compromising quality, (3) scalability because of the extrapolatability to unseen alterations in process parameters and across unseen materials without recalibration, and without prior knowledge or direct in-situ measurement of parameters, and (4) is rapid (e.g., correction times of approximately 6 seconds or less including hardware delay) as the method goes beyond part-to-part, layer-to-layer, road-to-road correction.

Some examples include an RL controller that is trained to determine future action parameters based on both the current state parameter represented by a quantified defect and the current action parameter of the production process. The RL controller is trained to make more informed decisions by leveraging information provided by the current action parameter of the production process.

Some examples include a computer-implemented method for training a RL model for adaptive process control as described herein that includes altering a single exogenous parameter of the production process while collecting training data. This approach allows the RL model to learn how to respond to changes in external factors that are not directly controlled by the system but can impact the production outcome. By learning from these variations controlled through altering a single exogenous parameter, the system can adapt to unexpected changes in exogenous parameters during actual production, enhancing its robustness and effectiveness.

According to examples of the present disclosure, a method for adaptive production control includes capturing an image of the product and processing the image to identify defect areas. The current state parameter is determined based on these defect areas, and, in particular, a void fraction may be calculated as the ratio of the defect area to the total area of the product in the image. The method provided herein may further include using a defect dynamics model to enhance the training of the RL model. The defect dynamics model predicts future state parameters based on current conditions and actions, capturing the complex, nonlinear relationships in the manufacturing process. The defect dynamics model may include separate neural networks for predicting quantitative defect metrics and qualitative defect states. The quantitative defect metrics and qualitative defect states may be used as input of the reward function of the RL model. It should be understood that the methods and systems described herein are not limited to using image data to identify defect areas. As described herein, other sensing technologies may be used to identify a defect, including, for example, various types of sensors and measurements.

According to examples of the present disclosure, a method for training a RL model for adaptive process control includes generating a training dataset that includes multiple training samples of a production process by altering a single exogenous parameter of the production process. A sample may contain a current state parameter represented by a quantified defect, and a current action parameter. In some examples, the RL model is then trained using this dataset to determine future action parameters based on current states and current actions. The training may be performed in a virtual environment that simulates the production process. In some examples, the method includes performing transfer learning to adapt the RL model trained in the virtual environment to a physical production process.

The methods provided herein may be applied to various production processes. The following examples are provided solely for purpose of illustration. For example, in a fused filament fabrication (FFF) 3D printing process, the method may be applied to control the filament extrusion speed. The reinforcement learning model can make real-time adjustments to the extrusion rate based on detected voids or over-extrusion, causing consistent layer adhesion. This adaptive control may compensate for variations in material properties or environmental conditions that might otherwise lead to print defects.

For example, in a direct ink writing process, the method may be applied to control the ink deposition speed. By continuously monitoring the quality of the deposited material and making real-time corrections, the system can maintain precise control over the geometry and properties of the printed structure.

For example, in a laser powder bed fusion 3D printing process, the method may be applied to control laser power and speed. The reinforcement learning model may adjust these parameters in real-time based on the thermal behavior of the melt pool, detected porosity, or surface roughness. This adaptive control may maintain consistent part density and mechanical properties across different regions of the build and when dealing with complex geometries and varying thermal conditions.

For example, in a direct energy deposition 3D printing process, the method may be applied to control laser power and speed. The system may adjust these parameters based on the detected melt pool characteristics, reducing defects such as lack of fusion or overheating. This adaptive control may be more beneficial when working with large parts or functionally graded materials.

For example, in a wire arc additive manufacturing 3D printing process, the method may be applied to control wire feed rate and torch speed. By continuously monitoring the bead geometry and heat input, the system can make real-time adjustments to maintain consistent deposition quality.

For example, in an incremental forming process, the method may be applied to control tool speed and pressure. The reinforcement learning model may adapt these parameters based on the detected forming forces and part geometry, causing consistent part quality and preventing material failure. This adaptive control may accommodate variations in material properties or complex part geometries that might otherwise require extensive manual tuning.

For example, in a laser micro-machining process, the method may be applied to control laser power and speed in real-time. By monitoring the quality of the machined features, the system can make continuous adjustments to maintain precise control over the ablation process. This adaptive approach may compensate for variations in material properties or laser beam characteristics, ensuring consistent feature quality across different regions of the workpiece.

For example, in a computer numerical control (CNC) milling process, the method may be applied to control cutting speed and tool speed. The reinforcement learning model may adjust these parameters based on detected cutting forces, vibration, or surface finish quality. This real-time adaptation can help maintain optimal cutting conditions across different materials and geometries, potentially reducing tool wear and improving overall part quality.

For example, in a semiconductor lithography process, the method may be applied to control exposure time and energy. By continuously monitoring the quality of the exposed features, the system can make real-time adjustments to compensate for variations in resist properties or environmental conditions. This adaptive control may help maintain consistent feature resolution and quality across the entire wafer.

For example, in a chemical vapor deposition process, the method may be applied to control gas flow rates. The reinforcement learning model may adjust these parameters based on in-situ measurements of film thickness or composition, resulting in uniform and high-quality thin film growth. This adaptive approach may compensate for variations in substrate temperature or precursor decomposition rates, which are critical for achieving desired film properties.

For example, in a welding process, the method may be applied to control current intensity in real-time. By monitoring the weld pool characteristics and joint geometry, the system can make continuous adjustments to maintain consistent weld quality. The adaptive control may compensate for variations in heat dissipation, material properties, or joint geometry, overcoming the disturbances caused by different welding conditions.

The systems and methods described herein are implemented via one or more computing systems. For example, an image of the product being processed may be input or otherwise accessed by one or more computing systems configured to perform adaptive process control as described herein. The computing systems are configured to perform adaptive process control and output a future action parameter and a control signal to adjust the production process by applying the future action parameter to the production process.

The one or more computing systems include system resources, non-transitory computer-readable storage media (data storage), and a communications interface. The non-transitory computer-readable storage media may contain instructions that, when executed, cause the one or more electronic processors (included in the system resources) to perform various functions described herein. In various implementations, the system resources include one or more electronic processors, one or more graphics processing units, volatile computer memory, non-volatile computer memory, and/or one or more system buses interconnecting the components of the computing system. In some examples, the communications interface includes hardware and software components that communicate with other elements of the system. For example, the system resources may communicate with one or more imaging modalities and/or one or more image databases or repository via the communications interface.

In various implementations, the communications interface supports/may be implemented according to one or more serial communication standards, including RS-232, RS-485, Universal Asynchronous Receiver/Transmitter (UART), Inter-Integrated Circuit (I2C), Serial Peripheral Interface (SPI), and/or Universal Serial Bus (USB). In some examples, the communications interface supports communicating over a Controller Area Network (CAN).

In various implementations, the communications interface may connect to various networks. These can include mobile networks such as General Packet Radio Service (GPRS), Time-Division Multiple Access (TDMA), Code-Division Multiple Access (CDMA), Global System for Mobile Communications (GSM), Enhanced Data Rates for GSM Evolution (EDGE), High-Speed Packet Access (HSPA), Evolved High-Speed Packet Access (HSPA+), Long Term Evolution (LTE), Worldwide Interoperability for Microwave Access (WiMAX), and/or 5th-generation mobile networks (5G). The communications interface may also connect to network types such as Internet Protocol (IP) networks, Wireless Application Protocol (WAP) networks, and/or IEEE 802.11 standards networks.

In some examples, the communications interface may connect to optical networks, local area networks (LANs), global communication networks like the Internet, and personal area networks (PANs) such as Bluetooth and Zigbee networks. In various implementations, the communications interface communicates with other devices via any of the previously described standards, networks, etc.

The storage may include one or more software applications, which one or more electronic processors and/or one or more graphics processing units of the system resources executes. The system resources may communicate with one or more human-machine interfaces, and operators can use the human-machine interfaces to interact with the running software applications.

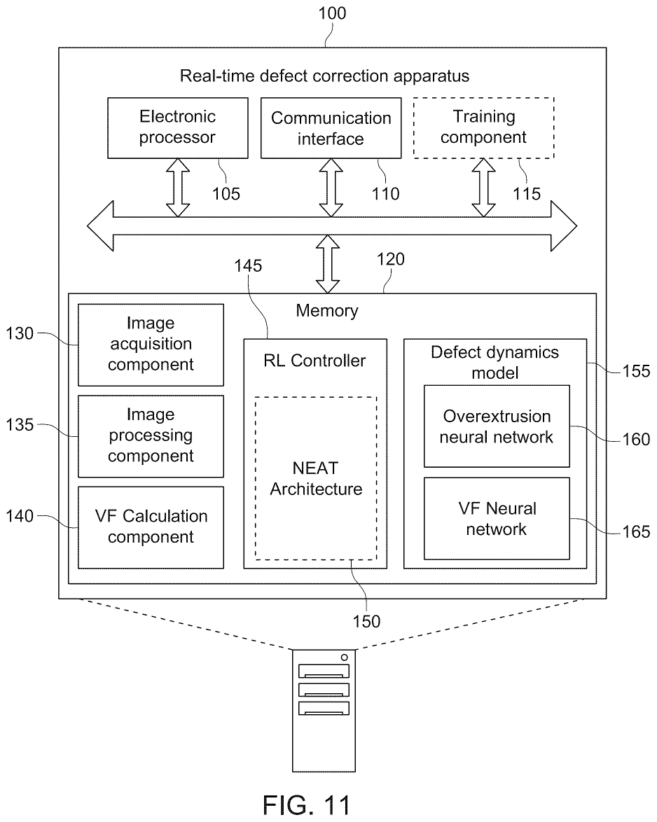

FIG. 11 illustrates an example of a real-time defect correction apparatus 100 that can be used to implement the methods and workflow described above. In some embodiments, the defect correction apparatus may be deployed within a Trusted Execution Environment (TEE). The real-time defect correction apparatus 100 includes electronic process 105, communication interface 110, and memory 120. The memory 120 includes image acquisition component 130, image processing component 135, void fraction (VF) calculation component 140, RL controller 145, and defect dynamics model 155 including over-extrusion neural network 160 and VF neural network 165. The real-time defect correction apparatus 100 may also include a training component 115, and the RL controller may also include a NeuroEvolution of Augmenting Topologies (NEAT) Architecture 150, where the RL controller may be trained by training component 115 to update the NEAT architecture.

In some examples, the image acquisition component 130 may capture images of the product being processed in real-time. The captured images may have a high-resolution that indicate a quantified defect of the product. The current state of the production may be represented by the quantified defect. For example, in 3D printing, the image acquisition component 130 may utilize a digital camera such as a USB microscope fixed on the extruder to continuously monitor the interface between adjacent roads or layers of the printed object.

In some examples, the image processing component 135 may include a Convolutional Neural Network (CNN) for analyzing the captured images. The image processing component 135 may classify the current printing state as Void, No Void, or Overprinting. The VF calculation component 140 takes the output of the image processing component 135 and quantifies the defects. For example, for images classified as having voids, The VF calculation component 140 may use color image segmentation techniques to calculate the areal void fraction. This may involve determining the ratio of the pixel area constituting the void to the pixel area of the image, providing a precise measure of the defect's severity.

In some examples, the RL controller 145 may include a reinforcement learning model. The RL controller taking as input the current state parameter (such as the void fraction) and the current action parameter (like filament speed in 3D printing). The controller's neural network policy may be designed to output the optimal future action parameter, such as the filament speed of the next action in the 3D printing process. The RL controller 145 may make real-time adjustments to the process parameters to correct defects.

The NEAT Architecture 150 may be updated during the RL controller's training process. The NEAT Architecture 150 may be used to update the RL neural network's parameters and structure. The NEAT Architecture 150 thus enhances the system's ability to adapt to new and unforeseen challenges, including potential cyberattacks. However, examples of the present disclosure are not limited thereto, and other architectures may be included in the RL controller.

The defect dynamics model 155 may generate outputs for training the RL Controller. The defect dynamics model 155 may include feedforward neural networks that predicts future defect states based on current conditions and actions. The feedforward neural networks may capture the complex, nonlinear relationships in the manufacturing process, including the effects of both endogenous and exogenous parameters. In some examples, the defect dynamics model 155 is trained on experimental data from two-road printing experiments with various combinations of process parameters and defect states.

For example, the defect dynamics model 155 includes the over-extrusion neural network 160 and VF neural network 165. The over-extrusion neural network 160 may predict qualitative defect states, such as the likelihood of over-extrusion. By using the over-extrusion neural network 160, real-time defect correction apparatus 100 balances the need to fill voids with the risk of depositing excessive material, which also lead to quality issues. The VF neural network 165 predicts future quantitative defect metrics, such as the void fraction. By including the VF neural network 165, real-time defect correction apparatus 100 anticipates how current actions will affect the severity of voids in subsequent layers or roads of the print.

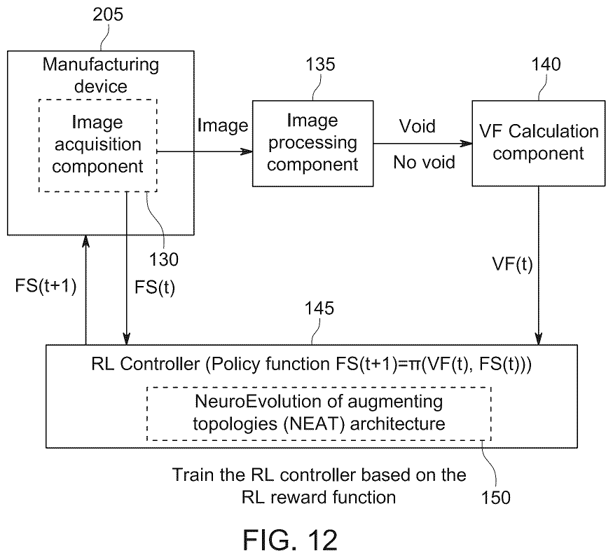

FIG. 12 illustrates an example implementation of the RL controller 145 configured to operate with the real-time defect correction apparatus 100. The RL controller 145 may receive, as inputs, one or more state parameters FSₜ from the manufacturing device 205 and defect-related image data processed by an image-processing component 135. In some embodiments, the manufacturing device 205 may be a fused filament fabrication (FFF) printer or other additive manufacturing systems including those in the abovementioned examples. The image-processing component 135 analyzes images acquired from an image-acquisition component 130 integrated within the manufacturing device 205 to determine the presence or absence of voids or other print-related defects. In some examples, the image-acquisition component 130 may be a digital microscope, Universal Serial Bus (USB) camera, or other optical imaging device including those in the abovementioned examples, integrated within or mounted on the manufacturing device 205. The image data is further processed by a void-fraction (VF) calculation component 140, which outputs a void fraction metric VFₜ indicative of the quality of the deposited material.

Based on these inputs, the RL controller 145 computes a future control action FSₜ₊₁ for the manufacturing device 205. The RL controller 145 executes a policy function that maps the current and predicted defect parameters (VFₜ, FSₜ) to the subsequent control parameter FSₜ₊₁. In some embodiments, the RL controller 145 employs a neuro-evolution architecture such as NeuroEvolution of Augmenting Topologies (NEAT) 150 to evolve and optimize network topologies over successive training iterations. The RL controller 145 may be trained using an RL reward function that penalizes the occurrence or predicted severity of void and rewards corrective actions that minimize defect propagation across print layers.

An example of the defect dynamics model 155 is further illustrated in FIG. 13. In some examples, the defect dynamics model 155 is a feedforward neural network that predicts a future state (VFₜ₊₁ and overprinting boolean OEₜ₊₁) using inputs of current states (VFₜ and OEₜ) and current and future actions (FSₜ and FSₜ₊₁). The RL reward function may be r=(1−VFₜ₊₁/VFₘ)(1−OEₜ₊₁), where VFₘ is the maximum permitted VF(e.g., 0.5 in some examples). In this equation, OE equals 0 for no overprinting and 1 for overprinting and the inclusion of this variable the equation creates a learned policy that prevents voids and overprinting.

In other embodiments, the defect dynamics model 155 includes an over-extrusion neural network 160 and a void-fraction neural network 165, each trained to predict corresponding defect metrics (OEₜ₊₁ and VFₜ₊₁) based on prior system states FSₜ, OEₜ, and VFₜ. The over-extrusion neural network 160 predicts the degree to which excess material deposition will occur given the current filament-speed parameter, while the void-fraction neural network 165 predicts the expected volume fraction of unfilled regions in the deposited material. The model thus captures the temporal evolution of defect states, enabling the RL controller 145 to anticipate how a current control action will affect future defect severity and overall print quality.

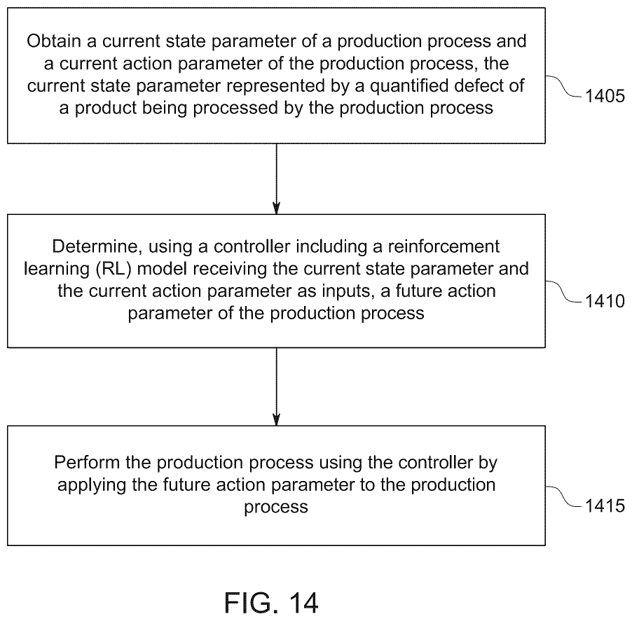

An example method for adaptive production control using the real-time defect correction apparatus 100 is illustrated in FIG. 14. At block 1405, a current state parameter and a current action parameter of the production process are obtained, the state parameter including a quantified defect measurement associated with a product currently being produced. These parameters may be obtained via the image acquisition component 130, image processing component 135, and VF calculation component 140 of the apparatus 100. At block 1410, the RL controller 145 determines, based on the current state and action parameters, a future action parameter—for example, an adjusted filament-speed command. At block 1415, the manufacturing device 205 performs the production process using the RL controller 145 by applying the future action parameter to control subsequent material deposition. In some examples, the method of FIG. 14 may be executed iteratively during real-time production to dynamically adjust process conditions in response to evolving defect metrics predicted by the defect-dynamics model 155.

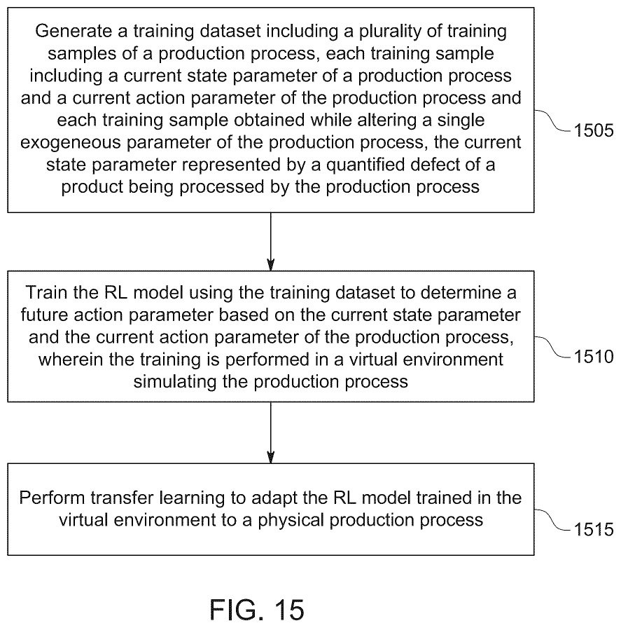

An example method for training the RL controller 145 for adaptive process control is illustrated in FIG. 15. At block 1505, a training dataset may be generated using the image processing component 135 to classify defect states, and the void-fraction (VF) calculation component 140 to quantify defect severity. The training dataset may include multiple samples that each capture a current state parameter and corresponding action parameter of the production process, while varying one or more exogenous parameters to produce quantifiable defects within the process output. At block 1510, the RL controller 145 is trained using the generated dataset to learn an optimal policy for predicting a future action parameter based on the observed state-action pairs, optionally within a virtual of simulated production environment. The training component 115 of the apparatus 100 may execute this training process, updating the NEAT architecture 150 of the RL controller 145 to optimize its performance. At block 1515, transfer learning may be performed to adapt the RL model trained in simulation to a physical manufacturing process, thereby compensating for hardware-specific characteristics and enabling effective real-time deployment of the trained policy. This adaption may also be facilitated by the training component 115, which interfaces with the manufacturing device 205 to validate and refine the RL controller's 145 performance in a live production setting.

According to other embodiments, adaptive process control may be achieved using a temporal contextual reinforcement learning (C-RL) method. In this embodiment, past trajectories of defect metrics (e.g., void fraction (VF), overprinting state (OE)) and real-time controllable process parameters (e.g., filament speed (FS), stage speed (S)) are encoded into latent variables using long short-term memory (LSTM) networks. These latent variables may capture temporal dependencies and nonlinear relationships between process behavior and defect evolution. A policy network, such as a fully connected neural network (FCNN), may receive the encoded latent variables and outputs a future trajectory of control actions over a defined time horizon. The trajectory accounts for controller hardware delay and is constrained to remain within predefined physical limits. The policy may be trained offline using a virtual environment composed of neural networks that simulate defect dynamics, with training data generated by varying at least one exogenous parameter. The reward function penalizes defect persistence and violations of hardware constraints, enabling the policy to produce temporally corrective actions that mitigate defects under time-varying exogenous conditions.

According to other embodiments, recovery from geometric attacks may be performed using a field-distribution-driven topology optimization method. This approach leverages multi-modal spatial distributions of geometry-dependent physical fields such as stress, strain, or displacement under various loading and boundary conditions, to detect and correct attack-induced alterations in the part geometry. For example, the field distribution of potentially corrupted geometry may be simulated and compared to the original to identify discrepancies that indicate geometric tampering. Topology optimization may then be used to iteratively add or remove material from the altered geometry to restore the original field behavior, while maintaining the same part volume.

According to other embodiments, adaptive process control may be achieved using a conditional reinforcement learning (ConRL) method. In this embodiment, the reinforcement learning policy is formulated as a neural network that receives two inputs: the current defect state, which may include quantitative metrics such as void fraction (VF) and qualitative indicators such as overprinting (OE), and the current action parameter, such as filament speed (FS) or stage speed (S). The policy may output a future action parameter intended to mitigate the defect in the next timestep. The policy may be trained using a virtual environment composed of feedforward neural networks that simulate defect dynamics. The training dataset may be generated by using at least one exogenous parameter including lateral stepover while collecting combinations of VFₜ, OEₜ, FSₜ, and FSₜ₊₁. The reward function used during training may penalize both void formation and overprinting and may include a penalty term that scales with the magnitude of change in FS when OE is present. The policy may be trained using NEAT, and once trained, the ConRL policy may be deployed for real-time control without requiring retraining or explicit identification of exogenous parameter versions. The descriptions included herein are merely illustrative in nature and does not limit the scope of the disclosure or its applications. The broad teachings of the disclosure may be implemented in many different ways. While the disclosure includes some particular examples, other modifications will become apparent upon a study of the drawings, the text of this specification, and the following claims. In the written description and the claims, one or more processes within any given method may be executed in a different order—or processes may be executed concurrently or in combination with each other—without altering the principles of this disclosure. Similarly, instructions stored in a non-transitory computer-readable medium may be executed in a different order—or concurrently—without altering the principles of this disclosure. Unless otherwise indicated, the numbering or other labeling of instructions or method steps is done for convenient reference and does not necessarily indicate a fixed sequencing or ordering.

As used herein, “real-time” refers to a system or process that responds and updates immediately or with minimal delay, typically within milliseconds or microseconds. This immediacy allows information to be accessed and acted upon almost instantaneously. As used herein, “real-time” also includes “near real-time,” which implies a slight but acceptable delay in data processing and response, such as within seconds or a few minutes. Accordingly, real-time can be contrasted with “batch processing” or “offline processing,” wherein data is collected, stored, and processed at a later time

It should also be noted that a plurality of hardware and software-based devices, as well as a plurality of different structural components may be utilized in various implementations. Aspects, features, and instances may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one instance, the electronic based aspects of the invention may be implemented in software (for example, stored on non-transitory computer-readable medium) executable by one or more processors. As a consequence, it should be noted that a plurality of hardware and software-based devices, as well as a plurality of different structural components may be utilized to implement the invention. For example, “control units” and “controllers” described in the specification can include one or more electronic processors, one or more memories including a non-transitory computer-readable medium, one or more input/output interfaces, and various connections (for example, a system bus) connecting the components.

Unless the context of their usage unambiguously indicates otherwise, the articles “a,” “an,” and “the” should not be interpreted to mean “only one. ” Rather, these articles should be interpreted to mean “at least one” or “one or more.” Likewise, when the terms “the” or “said” are used to refer to a noun previously introduced by the indefinite article “a” or “an,” the terms “the” or “said” should similarly be interpreted to mean “at least one” or “one or more” unless the context of their usage unambiguously indicates otherwise.

It should also be understood that although certain drawings illustrate hardware and software located within particular devices, these depictions are for illustrative purposes only. In some embodiments, the illustrated components may be combined or divided into separate software, firmware, and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable connections or links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations collectively. To reiterate, those electronic processors and processing may be distributed.

Spatial and functional relationships between elements—such as modules—are described using terms such as (but not limited to) “connected,” “engaged,” “interfaced,” and/or “coupled.” Unless explicitly described as being “direct,” relationships between elements may be direct or include intervening elements. The phrase “at least one of A, B, and C” should be construed to indicate a logical relationship (A OR B OR C), where OR is a non-exclusive logical OR, and should not be construed to mean “at least one of A, at least one of B, and at least one of C.” The term “set” does not necessarily exclude the empty set. For example, the term “set” may have zero elements. The term “subset” does not necessarily require a proper subset. For example, a “subset” of set A may be coextensive with set A, or include elements of set A. Furthermore, the term “subset” does not necessarily exclude the empty set.

In the figures, the directions of arrows generally demonstrate the flow of information—such as data or instructions. The direction of an arrow does not imply that information is not being transmitted in the reverse direction. For example, when information is sent from a first element to a second element, the arrow may point from the first element to the second element. However, the second element may send requests for data to the first element, and/or acknowledgements of receipt of information to the first element. Furthermore, while the figures illustrate a number of components and/or steps, any one or more of the components and/or steps may be omitted or duplicated, as suitable for the application and setting.

Additionally, operations (such as processes, decisions, inputs, outputs, actions, messages, interactions, events, and/or any other operations) shown in the flowcharts and/or message sequence charts may be illustrated once each and in a particular order in the drawings. However, in various implementations, the operations may be reordered and/or repeated as may be suitable. In some examples, different operations may be performed in parallel, as may be appropriate.

The term computer-readable medium does not encompass transitory electrical or electromagnetic signals or electromagnetic signals propagating through a medium —such as on an electromagnetic carrier wave. The term “computer-readable medium” is considered tangible and non-transitory. The functional blocks, flowchart elements, and message sequence charts described above serve as software specifications that can be translated into computer programs by the routine work of a skilled technician or programmer.

What is claimed is:

1. A method for adaptive process control, comprising:
obtaining a current state parameter of a production process and a current action parameter of the production process, the current state parameter represented by a quantified defect of a product being processed by the production process;
determining, using a controller including a reinforcement learning (RL) model receiving the current state parameter and the current action parameter as inputs, a future action parameter of the production process; and
performing the production process using the controller by applying the future action parameter to the production process.

2. The method of claim 1, wherein obtaining the current state parameter of the production process comprises:
obtaining an image of the product;
identifying a defect area in the image using one or more image processing models, the defect area indicating presence of a defect in the product; and
determining the current state parameter based on the defect area, wherein the current state parameter includes a void fraction calculated as a ratio of the defect area to an area of the product in the image.

3. The method of claim 1, wherein the current state parameter of the product is obtained based on a sensor signal of the product being processed by the production process.

4. The method of claim 1, wherein the RL model is trained using a defect dynamics model, wherein the defect dynamics model is trained to predict a future state parameter of a training production process based on a current state parameter of the training production process, a current action parameter of the training production process, and a future action parameter of the training production process.

5. The method of claim 4, wherein the defect dynamics model comprises:
a first predictive neural network for predicting a future quantitative defect metric; and
a second predictive neural network for predicting a future qualitative defect state.

6. The method of claim 1, wherein the RL model is trained on training data obtained by altering a single exogenous parameter of a training production process, wherein the training data is used to update parameters of the RL model and architecture of the RL model.

7. The method of claim 1, wherein the production process includes at least one selected from a group consisting of:
a fused filament fabrication (FFF) 3D printing process, wherein the action parameter includes filament extrusion speed;
a direct ink writing processing, wherein the action parameter includes an ink deposition speed;
a laser powder bed fusion 3D printing process, wherein the action parameter includes laser power;
a direct energy deposition 3D printing process, wherein the action parameter includes laser power and speed;
a wire arc additive manufacturing 3D printing process, wherein the action parameter includes wire and torch speed;
an incremental forming process, wherein the action parameter includes tool speed and pressure;
a laser micromachining process, wherein the action parameter includes laser power and speed;
a computer numerical control (CNC) milling process, wherein the action parameter includes cutting speed and tool speed;
a semiconductor lithography process, wherein the action parameter includes exposure time and energy;
a chemical vapor deposition process, wherein the action parameter includes gas flow rate; and
a welding process, wherein the action parameter includes current intensity.

8. A system for performing adaptive process control, comprising:
a sensor configured to obtain data representing a defect in a product being processed via a production process;
a controller including a reinforcement learning (RL) model, the controller configured to:
obtain a current state parameter of the production process determined based on the data obtained by the sensor;
obtain a current action parameter of the production process;
determine, with the RL model receiving the current state parameter and the current action parameter as inputs, a future action parameter of the production process, and
generate a control signal to adjust the production process by applying the future action parameter to the production process; and
an output interface configured to transmit the control signal.

9. The system of claim 8, wherein the sensor comprises an image capture device configured to capture an image of the product, and wherein the controller is further configured to:
identify a defect area in the captured image using one or more image processing models, the defect area indicating presence of the defect in the product, and
determine the current state parameter based on the defect area, wherein the current state parameter includes a void fraction calculated as a ratio of the defect area to an area of the product in the captured image.

10. The system of claim 8, wherein the current state parameter of the product is obtained based on a sensor signal of the product being processed by the production process.

11. The system of claim 8, wherein the controller is further configured to train the reinforcement learning model using a defect dynamics model, wherein the defect dynamics model is configured to predict a future state parameter of a training production process based on a current state parameter of the training production process, a current action parameter of the training production process, and a future action parameter of the training production process.

12. The system of claim 11, wherein the defect dynamics model comprises:
a first predictive neural network configured to predict a future quantitative defect metric; and
a second predictive neural network configured to predict a future qualitative defect state.

13. The system of claim 8, further comprising a training module configured to train the reinforcement learning model using a Neuro Evolution of Augmenting Topologies (NEAT) algorithm to update parameters of the reinforcement learning model and architecture of the reinforcement learning model.

14. The system of claim 8, wherein the production process includes at least one selected from a group consisting of:
a fused filament fabrication (FFF) 3D printing process, wherein the action parameter includes filament extrusion speed;
a direct ink writing processing, wherein the action parameter includes an ink deposition speed;
a laser powder bed fusion 3D printing process, wherein the action parameter includes laser power;
a direct energy deposition 3D printing process, wherein the action parameter includes laser power and speed;
a wire arc additive manufacturing 3D printing process, wherein the action parameter includes wire and torch speed;
an incremental forming process, wherein the action parameter includes tool speed and pressure;
a laser micromachining process, wherein the action parameter includes laser power and speed; a computer numerical control (CNC) milling process, wherein the action parameter includes cutting speed and tool speed;
a semiconductor lithography process, wherein the action parameter includes exposure time and energy;
a chemical vapor deposition process, wherein the action parameter includes gas flow rate; and
a welding process, wherein the action parameter includes current intensity.

15. A method for training a reinforcement learning (RL) model for adaptive process control, comprising:
generating a training dataset including a plurality of training samples of a production process, each training sample including a current state parameter of a production process and a current action parameter of the production process and each training sample obtained while altering a single exogenous parameter of the production process, the current state parameter represented by a quantified defect of a product being processed by the production process; and
training the RL model using the training dataset to determine a future action parameter based on the current state parameter and the current action parameter of the production process.

16. The method of claim 15, wherein a reward function of the reinforcement model rewards reduction in the quantified defect in the product.

17. The method of claim 16, wherein the reward function further penalizes violations of endogenous parameter limits of the production process.

18. The method of claim 15, wherein the training is performed in a virtual environment simulating the production process.

19. The method of claim 18, further comprising:
performing transfer learning to adapt the RL model trained in the virtual environment to a physical production process.

20. The method of claim 15, wherein the single exogenous parameter is lateral stepover in a three-dimensional (3D) printing process, and the current action parameter is an extrusion speed.
